(19) United States
(12) Patent Application Publication
(10) Pub. No.: US 2026/0219067 A1
(43) Pub. Date: Jul. 30, 2026

(54) SYSTEM AND METHOD FOR CROSS VALIDATION OF GROUND TRUTH USING MULTIPLE DATA SOURCES

(71) Applicant: Torc Robotics, Inc., Blacksburg, VA (US)

(72) Inventors: Maximilian Yassine Beyen, Leutenbach (DE); Uzair Bin Amjad, Baden-Wurttemberg (DE)

(21) Appl. No.: 19/037,020

(22) Filed: Jan. 24, 2025

(51) Int. Cl. G01C 21/00; G01S 19/39

(52) U.S. Cl. CPC G01C 21/3841; G01C 21/3893; G01S 19/39

(57) ABSTRACT

A system for cross validating ground truth data is disclosed. The system is configured to: receive, from a first vehicle, first sensor data including sensor data of a first navigation sensor positioned at the first vehicle, the first sensor data including perception data corresponding to a third vehicle; receive, from the second vehicle, second sensor data including sensor data of a second navigation sensor positioned at the second vehicle, the second sensor data including perception data corresponding to the third vehicle. and the first vehicle; identify a first position of the third vehicle based upon the first sensor data; identify a second position of the third vehicle based upon the second sensor data; and upon determining that a difference between the first position and the second position is within a predetermined threshold difference value, determine that the first sensor data is cross validated.

### TECHNICAL FIELD

The field of the disclosure relates generally to training a machine-learning model for an autonomous vehicle and, more specifically, cross validating ground truth data using multiple data sources including an aerial vehicle such as, a drone.

### BACKGROUND OF THE INVENTION

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Machine learning algorithms for perception technologies are trained using, for example, supervised machine learning techniques to process the sensed environment to identify and classify objects, or groups of objects, for example, pedestrians, vehicles, sign boards, or debris, etc. The machine learning algorithms, under supervised training, are trained by annotating various objects in the sensor data, for example, image data from camera sensors, or point cloud data from light detection and ranging sensors, using supervised machine learning techniques by human operators. Training machine learning algorithms using the supervised machine learning techniques is a laborious and time-consuming process. Additionally, accuracy of training the machine learning algorithms for perception technologies, for example, for actor prediction, tracking and object size estimation, using supervised machine learning techniques is affected by human bias. Further, validating and ensuring accuracy of a ground truth (GT) data source is crucial for training machine learning algorithms because each GT data source has its own limitations like range, view, occlusion, human in the loop, etc.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a system for cross validating ground truth data using multiple data sources including a first vehicle and a second vehicle. The system includes at least one memory configured to store instructions, and at least one processor coupled to the at least one memory is disclosed. The at least one processor is configured to execute the instructions to: (i) receive, from the first vehicle, first sensor data including sensor data of a first navigation sensor positioned at the first vehicle, the first sensor data including perception data corresponding to a third vehicle or a pseudo-object; (ii) receive, from the second vehicle, second sensor data including sensor data of a second navigation sensor positioned at the second vehicle, the second sensor data including perception data corresponding to the third vehicle or the pseudo-object, and the first vehicle, wherein the first sensor data and the second sensor data are collected by the first vehicle and the second vehicle, respectively; (iii) identify a first position of the third vehicle or pseudo-object based upon the first sensor data; (iv) identify a second position of the third vehicle or pseudo-object based upon the second sensor data; (v) determine when a difference between the first position of the third vehicle or pseudo-object and the second position of the third vehicle or pseudo-object is within a predetermined threshold difference value; and (vi) upon determining that the difference between the first position and the second position is within the predetermined threshold difference value, determine that the first sensor data is cross validated.

In another aspect, a computer-implemented method for cross validating ground truth data using multiple data sources including a first vehicle and a second vehicle is disclosed. The computer-implemented method includes (i) receiving, from the first vehicle, first sensor data including sensor data of a first navigation sensor positioned at the first vehicle, the first sensor data including perception data corresponding to a third vehicle or a pseudo-object; (ii) receiving, from the second vehicle, second sensor data including sensor data of a second navigation sensor positioned at the second vehicle, the second sensor data including perception data corresponding to the third vehicle or the pseudo-object, and the first vehicle, wherein the first sensor data and the second sensor data are collected by the first vehicle and the second vehicle, respectively; (iii) identifying a first position of the third vehicle or pseudo-object based upon the first sensor data; (iv) identifying a second position of the third vehicle or pseudo-object based upon the second sensor data; (v) determining when a difference between the first position of the third vehicle or pseudo-object and the second position of the third vehicle or pseudo-object is within a predetermined threshold difference value; and (vi) upon determining that the difference between the first position and the second position is within the predetermined threshold difference value, determining that the first sensor data is cross validated.

In yet another aspect, a non-transitory computer-readable media (CRM) having machine-executable instructions stored thereon is disclosed. The machine-executable instructions, when executed by at least one processor of a computing device, cause the computing device to cross validate ground truth data using multiple data sources including a first vehicle and a second vehicle by performing operations including (i) receiving, from the first vehicle, first sensor data including sensor data of a first navigation sensor positioned at the first vehicle, the first sensor data including perception data corresponding to a third vehicle or a pseudo-object; (ii) receiving, from the second vehicle, second sensor data including sensor data of a second navigation sensor positioned at the second vehicle, the second sensor data including perception data corresponding to the third vehicle or the pseudo-object, and the first vehicle, wherein the first sensor data and the second sensor data are collected by the first vehicle and the second vehicle, respectively; (iii) identifying a first position of the third vehicle or pseudo-object based upon the first sensor data; (iv) identifying a second position of the third vehicle or pseudo-object based upon the second sensor data; (v) determining when a difference between the first position of the third vehicle or pseudo-object and the second position of the third vehicle or pseudo-object is within a predetermined threshold difference value; and (vi) upon determining that the difference between the first position and the second position is within the predetermined threshold difference value, determining that the first sensor data is cross validated.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck;

FIG. 2 is a block diagram of the autonomous truck shown in FIG. 1;

FIG. 3 is a block diagram of an example computing system;

FIG. 4 is a diagram illustrating an example of driving a pseudo-object (PO) and an aerial vehicle, such as a drone, in a convoy with an ego vehicle;

FIG. 5 is an example representation of cross validation of perception data collected by the ego vehicle and the aerial vehicle with reference to the PO shown in FIG. 4; and

FIG. 6 is a flow diagram of an embodiment method of cross validating ground truth data using multiple data sources including an aerial vehicle such as, a drone.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments, and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

One or more of the following terms may be used in the disclosure, and their definition is provided below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

RTK-GNSS: Real-Time Kinematic (RTK) and Global Navigation Satellite System (GNSS) positioning are techniques for obtaining position information from satellite-based systems. RTK and GNSS, however, differ in terms of accuracy and methodology. RTK provides positional information that is precise in the order of centimeters based upon real-time correction signals received from a network of fixed reference stations with known positions (also referenced herein as rovers). GNSS, on the other hand, provides positional information that is precise in the order of several meters based upon time-of-flight computations of signals received from satellites that are affected by one or more of: satellite clock errors, atmospheric delays, or multipath errors.

PPK: Post-Processed Kinematics (PPK) is a methodology for accurate determination of a position and a trajectory of an object such as, an ego vehicle or a pseudo-object.

Ego vehicle: Ego vehicle, as described herein, refers to a vehicle equipped with sensors to perceive the environment surrounding the ego vehicle. The sensors may include one or more of: one or more camera sensors, one or more radio detection and ranging (RADAR) sensors, one or more light detection and ranging (LiDAR) sensors, one or more inertial measurement unit (IMU) sensors, etc. The ego vehicle may be an autonomous vehicle, a semi-autonomous vehicle, or a non-autonomous vehicle.

Pseudo-object: Pseudo-object (PO), as described herein, refers to a vehicle equipped with an RTK-GNSS system. The PO drives in a convoy with the ego vehicle and changes its position in the convoy over time.

Mission control: Mission control, as described in the present disclosure, refers to one or more application servers, and one or more database servers communicatively coupled with each other and one or more autonomous vehicles of a fleet. Mission control receives sensor data collected by one or more sensors of the one or more autonomous vehicles of the fleet and transmit data including, but not limited to, trajectory data, described herein, to the one or more autonomous vehicles of the fleet.

Training of machine learning algorithms using a supervised machine learning technique is a laborious and time-consuming process. Additionally, accuracy of training the machine learning algorithms for perception technologies, for example, for actor prediction, tracking and object size estimation, using supervised machine learning techniques is affected by human bias. The training data described herein for machine-learning algorithms for various perception tasks including, but not limited to, actor prediction, object size estimation, object tracking, etc., is obtained using an ego vehicle and a PO. Further, in order to improve accuracy of the ground truth (GT) data source, multiple GT data sources are used. Accordingly, in addition to the PO, an aerial vehicle, such as a drone, is also used for cross validation of the collected perception data.

As described herein, different GT sources are employed at the same time and place for cross validation and improving accuracy of the GT data. At least two different reference sources are used. Both the ego vehicle and the PO are equipped with a global navigation satellite system (GNSS) or inertial navigation system (INS). The GNSS/INS is a system that combines a GNSS receiver with an INS to provide precise positioning and attitude angles. Additionally, an aerial vehicle, such as a drone, may be used for an additional source of GT data. By way of an example, the aerial vehicle such as the drone may be a static drone.

In an overlapping region for which the drone and the ego vehicle both have acquired GT data, cross validation of the GT data may be performed, and thereby enhancing accuracy of the GT data and trust in the GT data sources. Further, more sources, for example, in addition to the drone, manual annotations may also be used for improving accuracy of the GT data. When reference vehicles equipped with GNSS/INS are validated for the corresponding vehicles in the drone data, all other vehicles in the view also become a source of Ground Truth in a broader view.

In some examples, position accuracy is evaluated by identifying two reference vehicles in the scene and tracking their positions over time. Distances measured by the ego vehicle and the aerial vehicle for one or more reference vehicles are compared; the difference between the distances measured by the ego vehicle and the aerial vehicle reduces in a few seconds, for example, 5 seconds or so. Accordingly, using multiple GT data sources, GT data can be cross validated, in addition to, identifying timestamps and scenarios where the accuracy is sufficiently high for different uses cases and filtering out inaccurate situations. Further, as described herein, more than one aerial vehicle and more than one reference vehicle may be used, and, thereby, strengths of different GT data sources are combined to enrich the data sources with more information.

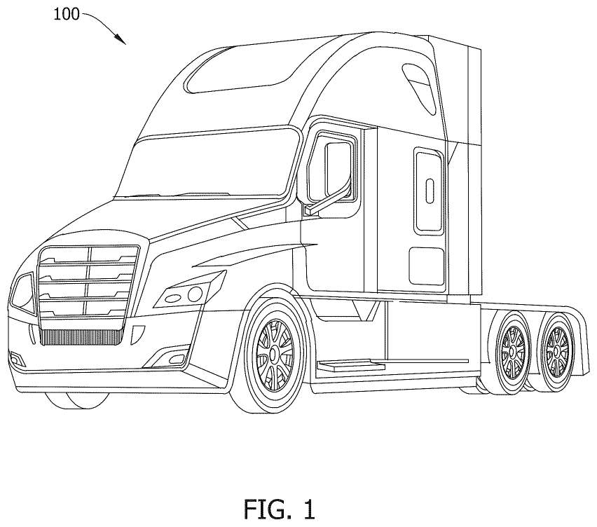

FIG. 1 illustrates a vehicle 100, such as a truck that may be conventionally connected to a single or tandem trailer to transport the trailer (not shown in FIG. 1) to a desired location. The vehicle 100 includes a cabin that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin.

The vehicle 100 may be an autonomous vehicle, in which case the vehicle 100 may omit the steering wheel and the steering column to steer the vehicle 100. Rather, the vehicle 100 may be operated by an autonomy computing system (not shown in FIG. 1) of the vehicle 100 based on data collected by a sensor network (not shown in FIG. 1) including one or more sensors. The vehicle 100 may be an ego vehicle referenced herein.

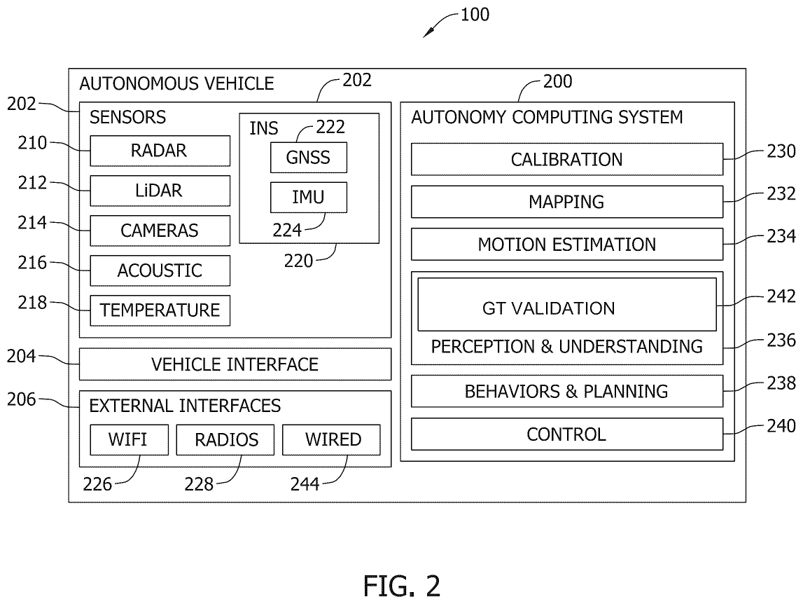

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, and navigation sensors. Navigation sensors, as described herein, may be one or more inertial navigation system (INS) sensors (or systems) 220, one or more global navigation satellite system (GNSS) sensors 222, or one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or mission control (a hub) or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment. Additionally, or alternatively, GNSS receiver 222 may be configured to receive RTK and GNSS position information from satellite-based systems.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a GT validation module 242. The GT validation module 242, for example, may be embodied within another module, such as behaviors and planning module 238, perception and understanding module 236, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The GT validation module 242, as described herein, cross validates multiple GT data sources, and selects timestamps and situations where the accuracy of the GT data sources exceeds a specific threshold condition for various use cases and filters out inaccurate situations. Additionally, or alternatively, functions performed by the GT validation module 242 may be implemented at a server. The server may be positioned at mission control.

Sensors 202, vehicle interface 204, external interfaces 206, calibration module 230, mapping module 232, motion estimation module 234, perception and understanding module 236, control module or controller 240, and GT validation module 242 of autonomy computing system 200 may also be positioned in another vehicle, such as a PO. The PO may be an autonomous vehicle, a semi-autonomous vehicle, or a non-autonomous vehicle.

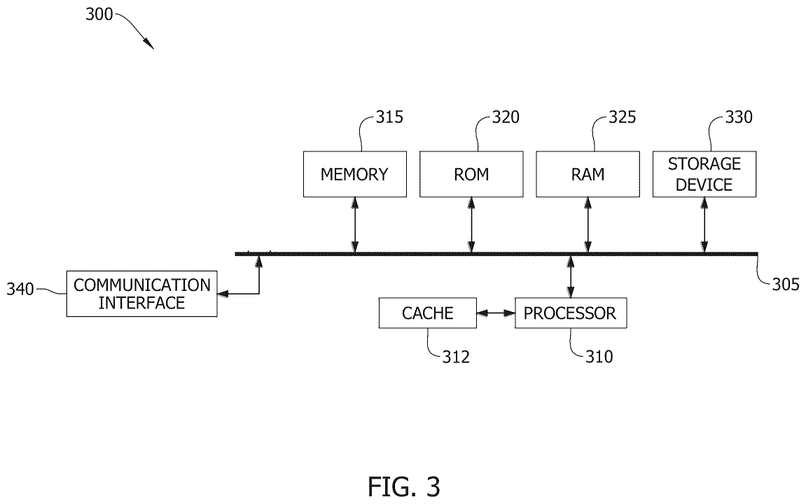

FIG. 3 illustrates an example computing system 300 that can implement various techniques, processes, functions, or methods described herein. The components of computing system 300 are shown in electrical communication with each other using a connection 305, such as a bus. The example computing system 300 includes a processing unit (CPU or processor) 310 and a computing device connection 305 that couples various computing device components, including computing device memory 315, such as a read only memory (ROM) 320 and a random-access memory (RAM) 325, and communication interface 340 to processor 310. The communication interface 340 may include one or more of a radio interface, an electronic sign board mounted on autonomous vehicle 100, a public address system or a loudspeaker positioned at autonomous vehicle 100. The radio interface may be configured for at least one of: (i) a vehicle-to-vehicle communication technique, (ii) citizens band radio frequencies; (iii) a Bluetooth signal; (iv) Wi-Fi; and (v) a short message service (SMS) technology.

Computing system 300 can include a cache 312 of high-speed memory connected directly with, in close proximity to, or integrated as part of processor 310. Computing system 300 can copy data from memory 315 and/or storage device 330 to cache 312 for quick access by processor 310. In this way, cache 312 can provide a performance boost that avoids processor 310 delays while waiting for data. These and other modules can control or be configured to control processor 310 to perform various actions. Other computing device memory 315 may be available for use as well. Memory 315 can include multiple different types of memory with different performance characteristics. Processor 310 can include any general-purpose processor, central processing unit (CPU), or graphics processing unit (GPU) in combination with a hardware or software provision configured to control processor 310 and stored in storage device 330, as well as any special-purpose processor where software instructions are incorporated into the processor design. Processor 310 may be a self-contained system, containing multiple cores or processors, a bus, memory controller, cache, etc. A multi-core processor may be symmetric or asymmetric.

Storage device 330 is a non-volatile memory and can be one or more of a hard disk or other types of computer readable media that can store data that are accessible by a computer, such as a magnetic cassette, flash memory card, solid state memory device, digital versatile disk, cartridge, RAM 325, ROM 320, or hybrids thereof. Memory 315 or storage device 330 can include software, code, firmware, etc., for controlling processor 310. Other hardware or software modules are contemplated. Memory 315 and storage device 330 are connected to computing device connection 305. In one aspect, a hardware module that performs a particular function can include the software component stored in a computer-readable medium in connection with the necessary hardware components, such as processor 310, computing device connection 305, and so forth, to carry out the function. In the example embodiment, processor 310 may be programmed by encoding an operation or function using one or more executable instructions and providing the executable instructions in memory 315 or storage device 330.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

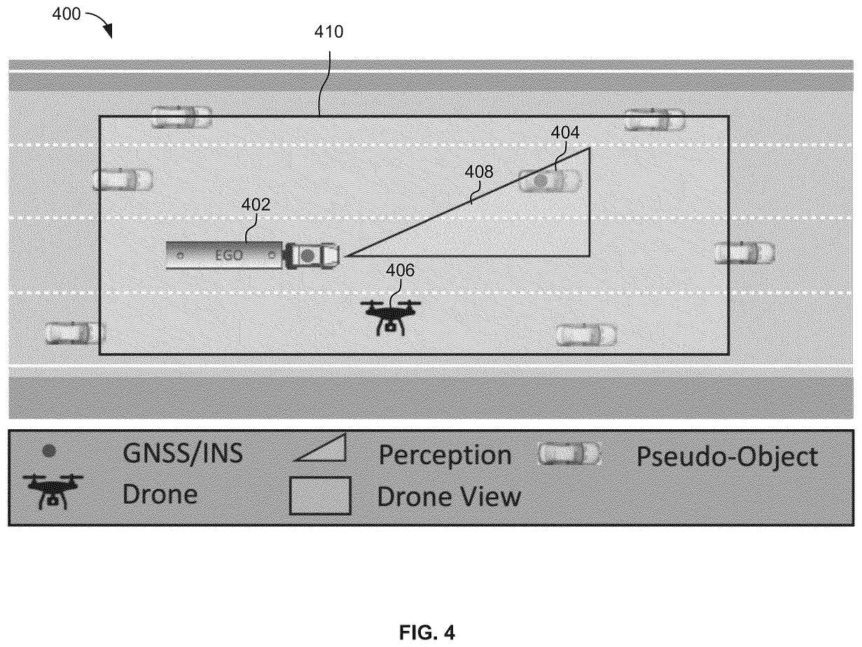

FIG. 4 illustrates an example system 400 to collecting and cross validating sensor data for generating accurate and trustworthy real world GT trajectory data as training data or a training dataset for training a machine learning algorithm for perception technologies. An ego vehicle 402 and a PO 404 each are equipped with a GNSS/INS system (that processes GNSS data using a processor, not shown in FIG. 4). The GNSS/INS system of ego vehicle 402 and PO 404 are time-aligned (or time-synchronized) with each other over GPS using GPS Time Synchronization Protocol. Both ego vehicle 402 and PO 404 drive in a convoy for a predetermined time period and collect sensor data while driving using one or more sensors mounted on the respective ego vehicle 402 and PO 404. Both ego vehicle 402 and PO 404 receive GNSS data from a GNSS satellite (not shown in FIG. 4). PO 404, while driving in the convoy, may drive to simulate various driving scenarios including, but not limited to, overtaking, lane changes, cut-in, etc. Based upon position of PO 404 with reference to ego vehicle 402, a zone 408 in FIG. 4 corresponds with a perception zone for ego vehicle 402. Ego vehicle 402 may be, for example, an autonomous vehicle. PO 404 may be, for example, another autonomous vehicle, a semi-autonomous vehicle, or non-autonomous vehicle.

Sensor data collected by PO 404 while driving in the convoy with ego vehicle 402 may include, but is not limited to, image data of one or more camera sensors, point cloud data of one or more LiDAR sensors, and position data. The position data may include, for example, GT trajectory data, and GT kinematic values such as, speed, acceleration, and attitude. Sensor data collected by ego vehicle 402 while driving in the convoy with PO 404 may include, but is not limited to, image data of one or more camera sensors, point cloud data of one or more LiDAR sensors, and position data such as, GT trajectory data.

An aerial vehicle 406 also equipped with one or more camera sensors, LiDAR sensors, RADAR sensors, and collects perception data including image data, point cloud data, and position data. The position data may include, for example, GT trajectory data, and GT kinematic values such as, speed, acceleration, and attitude, of the ego vehicle 402 and PO 404. The aerial vehicle 406 may be stationary. In some examples, the aerial vehicle 406 may be fixed at one location, and have a respective perception zone 410 within which the ego vehicle 402 and the PO 404 both are present. Since the zone 408 is within the perception zone 410, perception data collected by the aerial vehicle 406 cross validates the perception data collected by the ego vehicle 402.

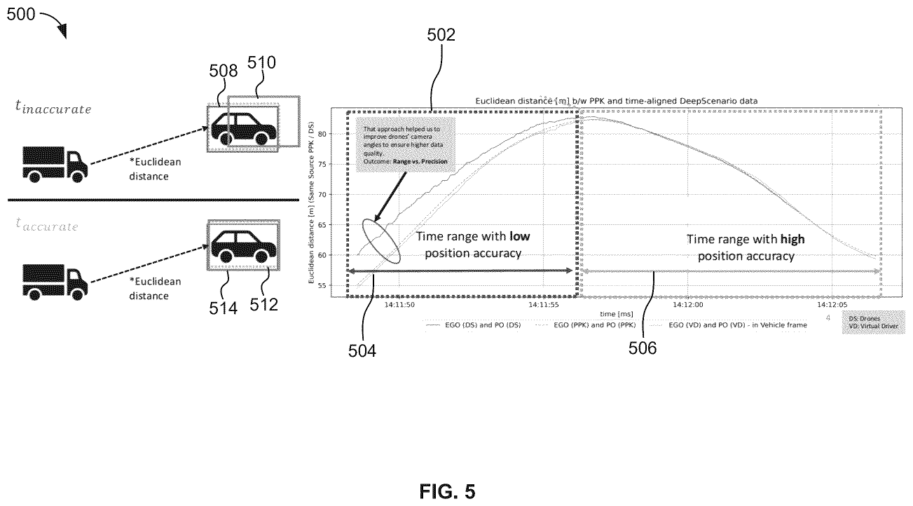

FIG. 5 is an example representation of cross validation of perception data collected by the ego vehicle 402 and the aerial vehicle 406 with reference to the PO 404. As shown in the diagram 500, a position accuracy may be evaluated by identifying at least two reference vehicles in a given scene, and tracking their respective positions over time. In the present case, the at least two reference vehicles corresponding with the ego vehicle 402 and the PO 404, or the aerial vehicle 406 and the PO 404. As illustrated in FIG. 5 using a chart 502, when the measured distance between the ego vehicle 402 reported position (for example, a first position) and the aerial vehicle 406 reported position of the PO 404 (for example, a second position) coincides with each other, or have a difference between the first and second positions within an acceptable margin of error or having a high position accuracy, the perception data collected by the ego vehicle is successfully cross validated.

In FIG. 5, a Euclidean distance between the ego vehicle 402 and the PO 404 position of the PO 404 as observed by the ego vehicle at time t_{inaccurate} 504 improves or becomes more accurate during time t_{accurate} 506. As shown in FIG. 5, a position of the PO 404 during time t_{inaccurate} 504 as measured or calculated by the ego vehicle 402 and the aerial vehicle 406, respectively, is shown as 508 and 510, which are different positions. However, the position of the PO 404 during time t_{accurate} 506 as measured or calculated by the ego vehicle 402 and the aerial vehicle 406, respectively, is shown as 512 and 514 coincides with each or have a difference that is within an acceptable margin of error or having a high position accuracy.

Accordingly, as described herein, multiple GT data sources, for example, the aerial vehicle 406 and the ego vehicle 402, may be cross validated for a given scene for which perception data is collected. By cross validating the captured perception data, timestamps and situations in which the perception data are more accurate may be identified. Additionally, by cross validating the captured perception data, captured perception data having an inaccuracy that is within a predefined threshold difference value may also be identified. In some examples, the predetermined threshold difference value may be within few centimeters, but not more than a meter.

Accordingly, perception data that is more accurate may be identified and selected for further operational tasks of the autonomous vehicle. And, perception data collected by the ego vehicle 402 and the aerial vehicle 406 which fails to be within the predefined threshold difference value may be discarded or ignored.

In other words, perception data collected by the ego vehicle 402 and the aerial vehicle 406 which fails to be within the predefined threshold difference value may not be used for an autonomous vehicle operation. By way of an example, the autonomous vehicle operation may include any one or more of: detection and identification of objects in the surrounding environment of the autonomous vehicle. Objects in the surrounding environment of the autonomous vehicle may include other vehicles, pedestrians, lane markings, traffic lights, and obstacles, etc., allowing the autonomous vehicle to understand its surroundings and make informed driving decisions like path planning and hazard avoidance.

While only one PO and one aerial vehicle are described for cross validation of the GT data, more than one PO and aerial vehicle may be used for cross validation of the GT data. Additionally, combining the strengths of different Ground Truth data sources like drones (birds-eye-view) and PPK GNSS/INS providing high global position and kinematic accuracy enriches the data sources with more information,

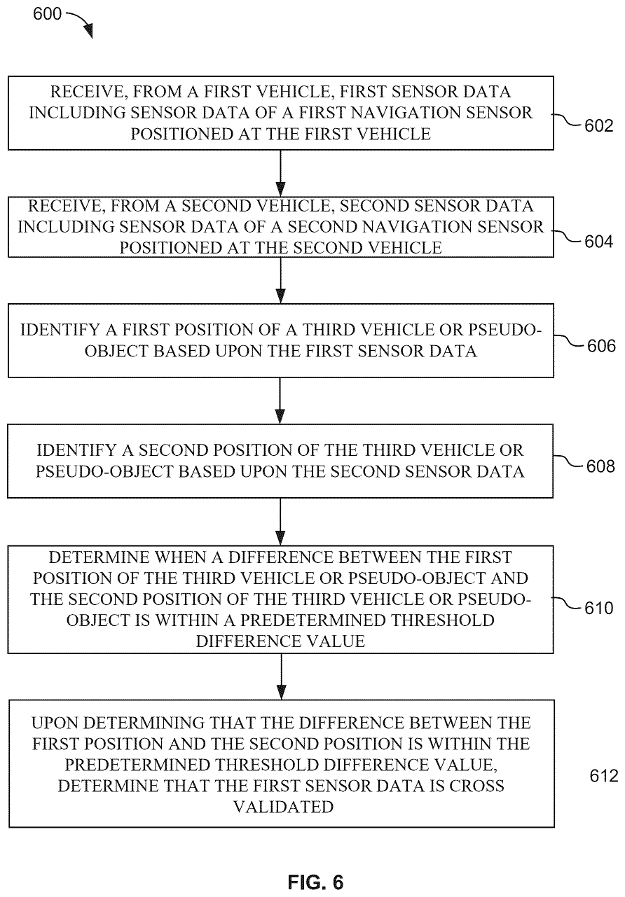

FIG. 6 is a flow diagram 600 of an embodiment method of cross validating ground truth data using multiple data sources including an aerial vehicle such as, a drone. The method operations may be performed by autonomy computing system 200 shown in FIG. 2 or a computing device shown in FIG. 3, which may be a server (or an application server) located at mission control. The method operations may be performed by the GT validation module 242 based upon sensor data of sensors 202.

The method operations include receiving 602 first sensor data from a first vehicle. The first sensor data includes sensor data of a first navigation sensor positioned at the first vehicle. The first vehicle may be an ego vehicle, as described herein. The first sensor data includes perception data corresponding to a third vehicle. The third vehicle may be a pseudo-object, as described herein. The first sensor data is collected by the first vehicle.

The method operations include receiving 604 second sensor data from a second vehicle. The second vehicle may be an aerial vehicle such as, a drone or a static drone, as described herein. The second sensor data include sensor data of a second navigation sensor positioned at the second vehicle. The second sensor data include perception data corresponding to the third vehicle and the first vehicle. The second sensor data is collected by the second vehicle. Further, the first navigation sensor is time synchronized with the second navigation sensor using a network time protocol (NTP) to synchronize with a global position system (GPS) time.

The method operations include identifying 606 a first position of the third vehicle or pseudo-object based upon the first sensor data, and identifying 608 a second position of the third vehicle or pseudo-object based upon the second sensor data, as described in detail herein. The first position of the third vehicle or pseudo-object is determined in accordance with a first Euclidean distance that is determined between the first vehicle and the third vehicle or pseudo-object based upon the first sensor data. The second position of the third vehicle or pseudo-object is determined in accordance with a second Euclidean distance that is determined between the first vehicle and the third vehicle or pseudo-object based upon the second sensor data.

The method operations include determining 610 when a difference between the first position of the third vehicle or pseudo-object and the second position of the third vehicle or pseudo-object is within a predetermined threshold difference value. The method operations include upon determining that the difference between the first position and the second position is within the predetermined threshold difference value, determining 612 that the first sensor data is cross validated. The cross validated data is considered having high accuracy and suitable for use in an autonomous vehicle operation.

The autonomous vehicle operation may include any one or more of: detection and identification of objects in the surrounding environment of the autonomous vehicle. Objects in the surrounding environment of the autonomous vehicle may include other vehicles, pedestrians, lane markings, traffic lights, and obstacles, etc., allowing the autonomous vehicle to understand its surroundings and make informed driving decisions like path planning and hazard avoidance.

An example technical effect of the methods, systems, and apparatus described herein includes at least improving safety of an autonomous vehicle as the autonomous vehicle can plan to operate using perception data that is cross validated and hence more accurate.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, including the implementation or utilization of components of the systems or steps independently and separately from other described components or steps. Therefore, it is manifestly intended that embodiments described herein be limited only by the claims.

What is claimed is:

1. A system for cross validating ground truth data using multiple data sources including a first vehicle and a second vehicle, the system comprising:
at least one memory configured to store instructions; and
at least one processor coupled to the at least one memory and configured to execute the instructions to:
receive, from the first vehicle, first sensor data including sensor data of a first navigation sensor positioned at the first vehicle, the first sensor data including perception data corresponding to a third vehicle or a pseudo-object;
receive, from the second vehicle, second sensor data including sensor data of a second navigation sensor positioned at the second vehicle, the second sensor data including perception data corresponding to the third vehicle or the pseudo-object, and the first vehicle, wherein the first sensor data and the second sensor data are collected by the first vehicle and the second vehicle, respectively;
identify a first position of the third vehicle or pseudo-object based upon the first sensor data;
identify a second position of the third vehicle or pseudo-object based upon the second sensor data;
determine when a difference between the first position of the third vehicle or pseudo-object and the second position of the third vehicle or pseudo-object is within a predetermined threshold difference value; and
upon determining that the difference between the first position and the second position is within the predetermined threshold difference value, determine that the first sensor data is cross validated.

2. The system of claim 1, wherein the first navigation sensor is time synchronized with the second navigation sensor using a global position system (GPS) time.

3. The system of claim 1, wherein the second vehicle is an aerial vehicle.

4. The system of claim 3, wherein the aerial vehicle is a static drone.

5. The system of claim 1, wherein to determine the first position of the third vehicle or pseudo-object, the at least one processor is further configured to execute the instructions to determine a first Euclidean distance between the first vehicle and the third vehicle or pseudo-object based upon the first sensor data.

6. The system of claim 1, wherein to determine the second position of the third vehicle or pseudo-object, the at least one processor is further configured to execute the instructions to determine a second Euclidean distance between the first vehicle and the third vehicle or pseudo-object based upon the second sensor data.

7. The system of claim 1, wherein the at least one processor is further configured to execute the instructions to discard or ignore the first sensor data and the second sensor data corresponding to determining a position of the third vehicle or pseudo-object until the difference between the first position and the second position is not within the predetermined threshold difference value.

8. A computer-implemented method for cross validating ground truth data using multiple data sources including a first vehicle and a second vehicle, the computer-implemented method comprising:
receiving, from the first vehicle, first sensor data including sensor data of a first navigation sensor positioned at the first vehicle, the first sensor data including perception data corresponding to a third vehicle or a pseudo-object;
receiving, from the second vehicle, second sensor data including sensor data of a second navigation sensor positioned at the second vehicle, the second sensor data including perception data corresponding to the third vehicle or the pseudo-object, and the first vehicle, wherein the first sensor data and the second sensor data are collected by the first vehicle and the second vehicle, respectively;
identifying a first position of the third vehicle or pseudo-object based upon the first sensor data;
identifying a second position of the third vehicle or pseudo-object based upon the second sensor data;
determining when a difference between the first position of the third vehicle or pseudo-object and the second position of the third vehicle or pseudo-object is within a predetermined threshold difference value; and
upon determining that the difference between the first position and the second position is within the predetermined threshold difference value, determining that the first sensor data is cross validated.

9. The computer-implemented method of claim 8, wherein the first navigation sensor is time synchronized with the second navigation sensor using a global position system (GPS) time.

10. The computer-implemented method of claim 8, wherein the second vehicle is an aerial vehicle.

11. The computer-implemented method of claim 10, wherein the aerial vehicle is a static drone.

12. The computer-implemented method of claim 8, wherein determining the first position of the third vehicle or pseudo-object further comprises determining a first Euclidean distance between the first vehicle and the third vehicle or pseudo-object based upon the first sensor data.

13. The computer-implemented method of claim 8, wherein determining the second position of the third vehicle or pseudo-object \further comprises determining a second Euclidean distance between the first vehicle and the third vehicle or pseudo-object based upon the second sensor data.

14. The computer-implemented method of claim 8, further comprising discarding or ignoring the first sensor data and the second sensor data corresponding to determining a position of the third vehicle or pseudo-object until the difference between the first position and the second position is not within the predetermined threshold difference value.

15. A non-transitory computer-readable media (CRM) having machine-executable instructions stored thereon, which, when executed by at least one processor of a computing device, cause the computing device to cross validate ground truth data using multiple data sources including a first vehicle and a second vehicle by performing operations comprising:
receiving, from the first vehicle, first sensor data including sensor data of a first navigation sensor positioned at the first vehicle, the first sensor data including perception data corresponding to a third vehicle or a pseudo-object;
receiving, from the second vehicle, second sensor data including sensor data of a second navigation sensor positioned at the second vehicle, the second sensor data including perception data corresponding to the third vehicle or the pseudo-object, and the first vehicle, wherein the first sensor data and the second sensor data are collected by the first vehicle and the second vehicle, respectively;
identifying a first position of the third vehicle or pseudo-object based upon the first sensor data;
identifying a second position of the third vehicle or pseudo-object based upon the second sensor data;
determining when a difference between the first position of the third vehicle or pseudo-object and the second position of the third vehicle or pseudo-object is within a predetermined threshold difference value; and
upon determining that the difference between the first position and the second position is within the predetermined threshold difference value, determining that the first sensor data is cross validated.

16. The non-transitory CRM of claim 15, wherein the first navigation sensor is time synchronized with the second navigation sensor using a global position system (GPS) time.

17. The non-transitory CRM of claim 15, wherein the second vehicle is an aerial vehicle or a static drone.

18. The non-transitory CRM of claim 15, wherein determining the first position of the third vehicle or pseudo-object further comprises determining a first Euclidean distance between the first vehicle and the third vehicle or pseudo-object based upon the first sensor data.

19. The non-transitory CRM of claim 15, wherein determining the second position of the third vehicle or pseudo-object \further comprises determining a second Euclidean distance between the first vehicle and the third vehicle or pseudo-object based upon the second sensor data.

20. The non-transitory CRM of claim 15, wherein the operations further comprise discarding or ignoring the first sensor data and the second sensor data corresponding to determining a position of the third vehicle or pseudo-object until the difference between the first position and the second position is not within the predetermined threshold difference value.
